(19) United States
(12) Patent Application Publication
(10) Pub. No.: US 2012/0303582 A1
(43) Pub. Date: Nov. 29, 2012

(54) LOCAL DIFFERENTIAL COMPRESSION

(75) Inventors: David Robert Seaman, Mississauga (CA); Blair James Wall, Toronto (CA); Christopher Carl Capson, Pickering (CA)

(73) Assignee: Syntergy, Inc., Vaughan (CA)

(21) Appl. No.: 13/117,135

(22) Filed: May 27, 2011

(51) Int. Cl. G06F 7/00

(52) U.S. Cl. 707/638; 707/E17.01; 707/E17.032

(57) ABSTRACT

The disclosure is related to systems and methods of local differential compression. Local differential compression can allow a computer to transfer data efficiently over a limited or restricted bandwidth network. For example, a first computer can be adapted to synchronize a data object between the first computer and a second computer by: determining a list of portions of a data object to synchronize and sending the list to the second computer. When the second computer has received the list, the second computer may build the data object based on the list, data retrieved corresponding to the list, and other data already existing at the second computer.

### BACKGROUND

The present disclosure is generally related to compression of data for transmission over a network. Every network has an associated maximum data transfer rate based on the bandwidth of the network. As a result of limited bandwidth, users can experience long delays or lost data in retrieving and transferring data across a network. Further, some networks, due to limited bandwidth or restrictions on bandwidth use, may not be able to support large data transfers over the network.

For example, Remote Differential Compression (RDC) allows a sending computer to transmit a signature file to a receiving computer so that the receiving computer can determine differences between a version of a file at the sending computer and another version of the file at the receiving computer. However, an RDC signature file can be relatively large for a low bandwidth network. Thus, the size of an RDC signature file can be prohibitive to synchronize data over a limited or restricted bandwidth network.

### BRIEF DESCRIPTION OF THE DRAWINGS

FIG. 1 is a diagram of an illustrative embodiment of a system for local differential compression;

FIG. 2 is a diagram of another illustrative embodiment of a system for local differential compression;

FIG. 3 is a flowchart of an illustrative embodiment of a method for local differential compression; and

FIG. 4 is a flowchart of an illustrative embodiment of a method for local differential compression.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present disclosure.

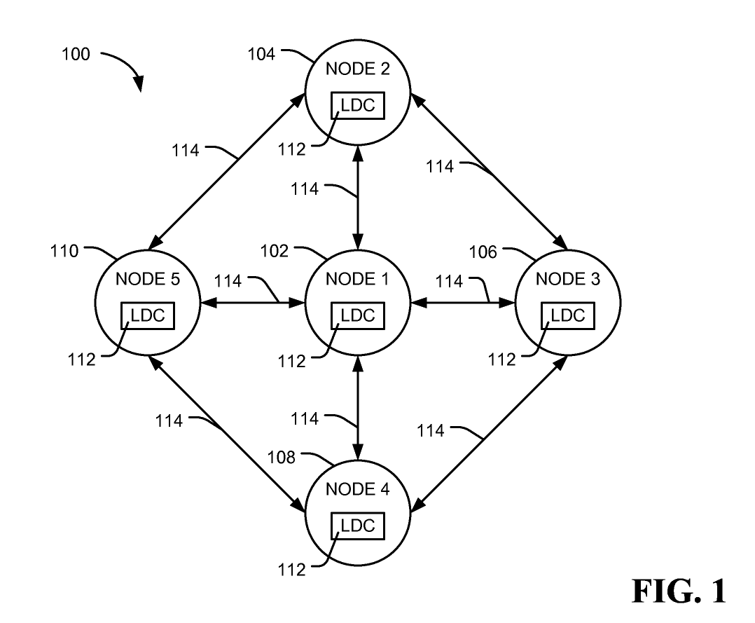

Referring to FIG. 1, a particular embodiment of a system for local differential compression (LDC) is shown and generally designated 100. The system 100 can include multiples nodes, such as nodes 102, 104, 106, 108, and 110. A node may be a general purpose computing device, a special purpose computing device, or any other appropriate device that can connect to a network. For example, a node may be a personal computer, a laptop computer, a desktop computer, a server, a phone, a tablet computer, a media player, or any other device that is capable of connecting to a network and implementing the systems or methods described herein. The network 114 may correspond to any connectivity topology including, but not limited to: a direct wired connection (e.g. parallel port, serial port, USB, IEEE 1394, etc.), a wireless connection (e.g. IR port, Bluetooth port, etc.), a wired network, a wireless network (e.g. 802.11x, cellular, etc.) a local area network, a wide area network, an ultra-wide area network, an internet, an intranet, and an extranet.

A node, such as node 102, etc., may include an LDC module 112 that can be implemented as software or firmware to be executed by a processor. The LDC module 112 could also be implemented as a hardware circuit or a combination of hardware circuit and software. Generally, a node may include a memory having a cache (not shown), a processing device (not shown), and an interface (not shown) to transmit or receive over the network 114. The memory may be volatile or non-volatile memory, or any combination of the thereof. A node may also have additional features or functionality and may include input or output devices. For example, a node may include an operating system that may execute one or more application programs, or modules, that reside in a memory, such as the LDC module 112.

The LDC module 112 may implement synchronization of a data object, such as a file, between two nodes of the network 114. The LDC module 112 allows a node to transfer data efficiently over the network 114. This solves a need in the market for efficient transfer of data over networks, especially low or restricted bandwidth networks. For example, a first node can be adapted to synchronize a data object between the first node and a second node. The first node may determine a list of portions of the data object that are different than corresponding portions of a previous version of the data object that is at the second node; the first node may then send the list to the second node. When the second node has received the list, the second node may build the data object based on the list, data retrieved corresponding to the portions identified in the list, and other data already existing at the second node. By first determining which portions the second node needs, the LDC module can significantly reduce an amount of data sent over the network 114 to synchronize data when compared with other ways of synchronizing data, such as Remote Differential Compression (RDC).

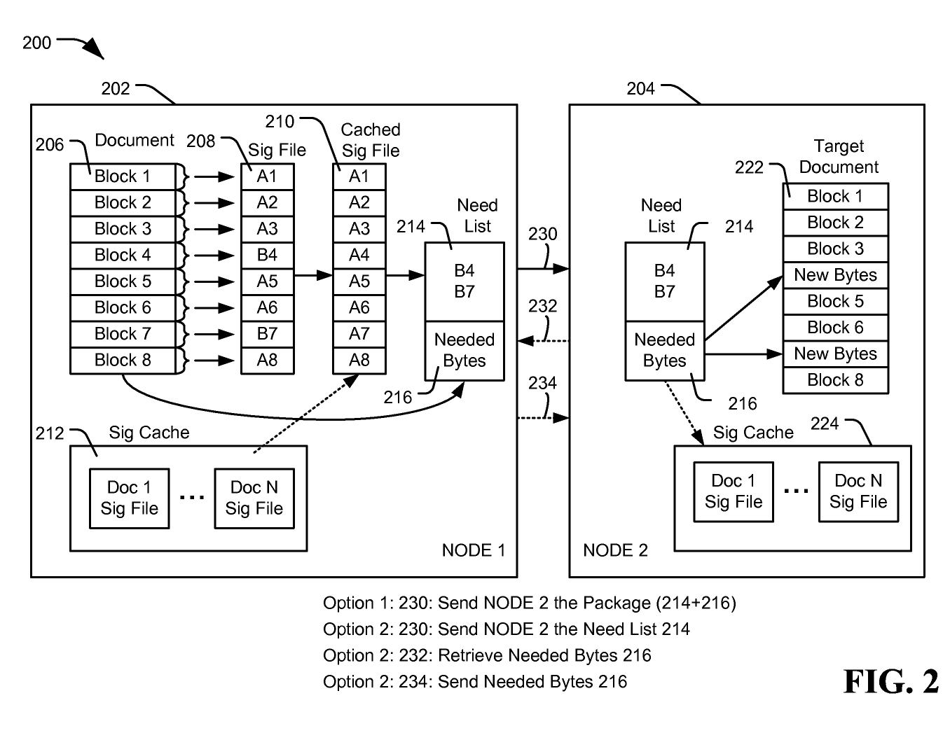

Referring to FIG. 2, a particular embodiment of a system for Local Differential Compression is shown and generally designated 200. The system 200 may include a first node 202 and second node 204, such as nodes 102-110 shown in FIG. 1, and the nodes may include hardware or software to implement LDC.

During operation, the first node 202 can determine a document 206 (or data object) has been updated, changed, or selected. The document 206 may be selected when any indicator determines it should be synchronized with another node, such as changes to the document, a timer, a user selection, or any type of trigger. The document may then be organized into portions (represented as Block 1, Block 2, etc.) and a signature value for each portion can be calculated (represented as A1, A2, A3, B4, A5, A6, B7, and A8). The portions can be like sized portions or may be varying sized portions and the signature values can be grouped or combined into a signature file 208. The signature file 208 may be compared to a previously stored signature file 210 that may be retrieved from a cache 210. The cache 210 may be local to the first node 202 to reduce the amount of data needing to be sent over a network. The previously stored signature file 210 can correspond to a previous version (or some other version) of the document 206 located at the second node 204. A signature value or signature file may be determined by applying a hash function to data, such as by applying a hash function to each portion of the document 206.

The first node 202 may then compare the signature file 208 to the previously stored signature file 210 to determine any differences between the signature files. The differences, i.e. the portions of the document that are identified as changed or different, between the signature files may be stored in a list 214, or “need list”. In some embodiments, the need list 214 may be combined into a package with data 216 that corresponds to the portions that are identified in the need list 214. In another embodiment, the need list comprises one or more start address and an indicator of a length of data to send, where the data corresponds to the portions identified in the need list.

The first node 202 may then send the need list 214 to the second node 204. In some embodiments, the package including the need list 214 and the data 216 can be sent in a generally continuous transmission (i.e. without interruption from the second node 204) to the second node 204. In some embodiments, the second node 204 can receive the need list 214, via transmission 230, and determine when to retrieve the data corresponding to the portions identified in the need list 214. This can occur when the cache 204 does not have the data corresponding to the need list. When the second node 204 retrieves the data corresponding to the portions identified in the need list 214, the second node 204 may send a notice, via transmission 232, to the first node 202 (or another node identified as having the corresponding data) to transfer the data 216. The first node 202 (or other selected node) may then transfer the data 216, via transmission 234, to the second node 204 in response to the notice.

When the second node 204 has the data 216, it may build a synchronized copy 222 of the document 206 by combining the data 216 with other data at the second node. In some instances, the data 216 may not need to be sent from the first node 202 to the second node 204 because the need list 214 may include references to data that the second node 204 already has available, such as in the cache 224, or can more easily obtain than via a transfer from the first node 202; thus, there may be no need to transfer the data 216 from the first node 202. For example, the other data may be acquired by: retrieving data existing from the cache 224 at the second node 204 (such as due to the existence of another version of the document), retrieving data from another network or location that may have a higher bandwidth or faster connection to the second node 204 than the first node 202, or any combination thereof.

Either the first node 202 or the second node 204 can determine if the second node 204 already has data corresponding to the portions in the list. This can be done by comparing the need list to an inventory of what is stored in the cache 224 of the second node 204. In embodiments where the first node 202 includes an inventory list or a cache 212 synchronized with the cache 224 at the second node 204, the first node 202 may perform the determination. In other instances, the second node 204 may receive the need list 214 and perform the determination. Thus, the data corresponding to the need list 214 may be sent from the first node 202 to the second node when the second node 204 does not have the data corresponding to the need list 214. Further, only the need list 214 may need to be sent to the second node 204 when the second node 204 has all of the data corresponding to the need list 214.

Once the document 222 has been constructed, the second node 204 may determine a signature file for the document 222 and store it to a cache 224 along with document 222, which may be local to the second node 204. In addition, the signature file 208 may be stored in the cache 212 while the previously stored signature file 210 may be deleted. The system 200 may implement cache management techniques to ensure the cache for the first node 202 and the second node 204 stay synchronized. The cache management techniques may be implemented when there is sufficient bandwidth over a network to perform cache synchronization operations without interfering with or delaying other communication over the network. In addition, the cache management techniques may be done via a direct connection of the caches or via an intermediary storage device.

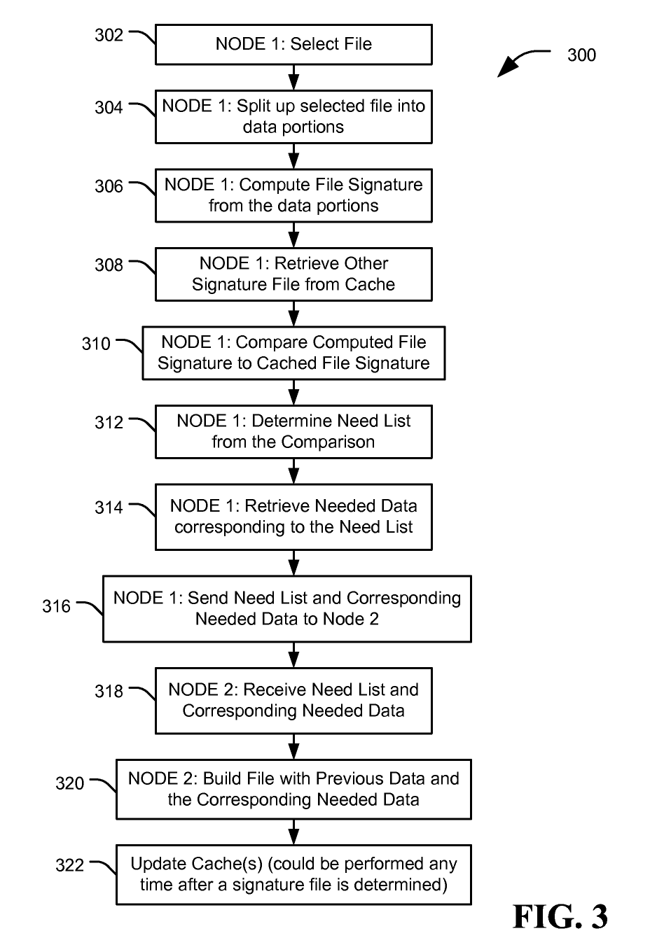

Referring to FIG. 3, a flowchart of an illustrative embodiment of a method for local differential compression is shown and generally designated 300. The method 300 is generally applicable to synchronize data objects (such as files) between one node in a network to another node in the network, such as nodes 102-110 shown in FIG. 1 or nodes 202-204 shown in FIG. 2. The method 300, and LDC generally, is particularly useful for networks with low-available bandwidth, such as a network with an overall low-bandwidth or a network with restrictions on bandwidth such as a network with a bandwidth allotment per user or per data transfer or per connection.

The method 300 may be implemented by a first node that can perform a process, or method, including selecting a file (or document, or data object, etc.), at 302. A file may be selected based on a recent update or change, a timed synchronization indicator, error detection, a request by another node, a selection by a user, a selection by another application program, or any other method. Once the file is determined, the file may then be organized into portions, at 304. A signature value for each portion can be calculated and a signature file may be determined based on the signature values, at 306. Another signature file may then be retrieved from a cache, at 308, and compared to the signature file, at 310. The other signature file can correspond to a different version of the file, where the different version of the file may still be located at a second node.

The first node may determine any differences between the other signature file and the signature file and store the differences in a need list, at 312. The differences may include portions of the file that are identified as changed or different between the signature files. Data that corresponds to the portions identified in the need list may be retrieved, at 314. The first node may then send the need list and the corresponding data to the second node that has the different version of the file, at 316. In some embodiments, a package including the need list and the corresponding data can be sent in a generally continuous transmission (i.e. without interruption from the second node) to the second node.

When the second node receives the need list and the corresponding data, at 318, the second node may build a synchronized copy of the file by combining the corresponding data with other data at the second node, at 320. The other data may be acquired by: retrieving data already existing at the second node (such as due to the existence of the different version of the document from a cache at the second node), retrieving data from another network or location that may have a higher bandwidth or faster connection to the second node than the first node, or any combination thereof. Once the file has been synchronized, the second node may determine a signature file for the document store it to a cache, at 322, along with the built file. In addition, the signature file may be stored in a cache at the first node along with the data file (i.e. the data corresponding to the signature file).

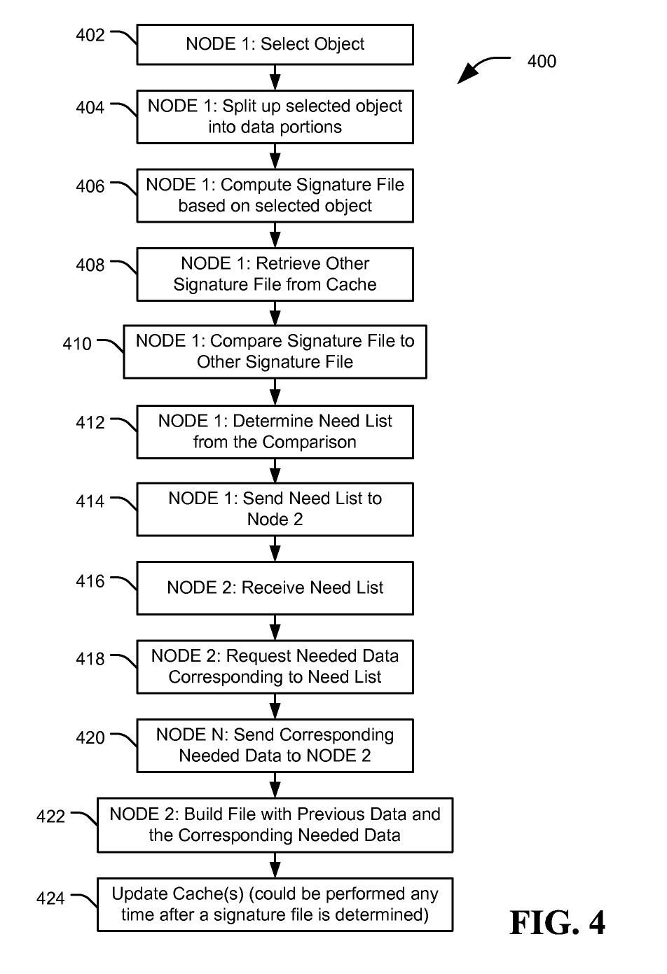

Referring to FIG. 4, a flowchart of an illustrative embodiment of a method for local differential compression is shown and generally designated 400. The method 400 is generally applicable to synchronize data objects (such as files) between one node in a network to another node in the network, such as nodes 102-110 shown in FIG. 1 or nodes 202-204 shown in FIG. 2. The method 400, and LDC generally, is particularly useful for synchronizing data objects over networks with low-available bandwidth, such as a network with an overall low-bandwidth or a network with restrictions on bandwidth per user or per data transfer or per connection.

The method 400 may be implemented by a first node that can perform a process, or method, including selecting an object (such as a document, a file, a folder, a group of files, etc.), at 402. An object may be selected based on a recent update or change, a timed synchronization indicator, error detection, a request by another node, a selection by a user, a selection by another application program, or any other method. Once the object is determined, the object may then be organized into portions, at 404. A signature value for each portion can be calculated and a signature file may be determined based on the signature values, at 406. At any time after determining the signature file, the signature file may be stored in a cache accessible to the first node.

Another signature file may then be retrieved from a cache, at 408, and compared to the signature file, at 310. The other signature file can correspond to a version of the object, where a second node may still have the version of the object stored in memory. The first node may determine any differences between the other signature file and the signature file and then store any differences in a need list, at 412. The differences may include portions of the object that are identified as changed or different based on the comparison of the signature files. The need list may then be sent to the second node, at 414.

When the second node receives the need list, at 416, the second node may determine when to synchronize the version of the object stored in the second node. The update may occur soon after receiving the need list or may occur at a later time as determined by the second node. Once the second node determines to synchronize the version of the object, the second node may retrieve the data corresponding to the need list by either sending a request for the data to another node or accessing it from the cache on node 2, at 418. In one example, the second node can retrieve the data from the first node; however, in other examples, the second node may retrieve the data from another node other than the first node. The second node may choose where to retrieve the data from based on a proximity of the data to the second node, a bandwidth connection between nodes, an amount of time to retrieve the data from different nodes, a preference indicator for a certain node, or any other selection criteria.

In response to the request to retrieve the data, the request receiving node (Node N) may transmit the data to the second node, at 420. When the second node receives the data, the second node may build a synchronized copy of the object by combining the data with other data at the second node, at 422. The other data may be acquired by: retrieving data already existing at the second node (such as due to the existence of the previous version of the object), retrieving data from another network or location that may have a higher bandwidth or faster connection to the second node than the first node, retrieving data from a preferred node, or any combination thereof. Once the object has been synchronized, the second node may determine a signature file for the object and store it to a cache, at 424.

In accordance with various embodiments, the methods described herein may be implemented as one or more software programs running on a computer processor, controller, or other control circuit. Dedicated hardware implementations including, but not limited to, application specific integrated circuits, programmable gate arrays, and other hardware devices can likewise be constructed to implement the systems and methods described herein. The systems and methods described herein can be applied to any type of system or computer that transfers data over a network.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

The illustrations and examples provided herein are but a few examples of how the present disclosure can be applied to data storage systems. There are many other contexts in which the methods and systems described herein could be applied to computing systems and data storage systems. For example, the methods and systems described herein are particularly useful for low bandwidth networks or networks imposing a bandwidth limit on a user or on data transmissions.

This disclosure is intended to cover any and all subsequent adaptations or variations of various embodiments. Combinations of the above embodiments, and other embodiments not specifically described herein, will be apparent to those of skill in the art upon reviewing the description. Additionally, the illustrations are merely representational and may not be drawn to scale. Accordingly, the disclosure and the figures are to be regarded as illustrative and not restrictive.

What is claimed is:

1. A method comprising:
synchronizing a data object between a first node and a second node including:
processing in the first node including:
partitioning the data object into portions;
determining a signature for each of the portions to produce a first object signature;
retrieving a previously stored object signature from a cache, the previously stored object signature corresponding to a previous version of the data object;
comparing the first object signature to the previously stored object signature;
creating a list of the portions of the data object that are different than corresponding portions of the previous version based on the comparison; and
sending the list to the second node.

2. The method of claim 1 further comprising:
determining if the second node already has data corresponding to the portions in the list;
sending the data from the first node to the second node when the second node does not have the data corresponding to the portions in the list; and
only sending the list to the second node when the second node does have all of the data corresponding to the portions in the list.

3. The method of claim 2 further comprising:
processing at the second node including:
receiving the list indicating the portions of the data object that are different than a previous version of the data object;
receiving the data corresponding to the portions in the list when the data is needed from the first node; and
building the data object in the second node by combining the data with other portions of the data object that are already present in the second node.

4. The method of claim 2 further comprising sending the data when the list is sent, without receiving any intervening responses from the second node.

5. The method of claim 2 further comprising sending the data in response to a request for the data from the second node.

6. The method of claim 1 wherein the signature for each of the portions is determined by applying a hash function to each of the portions.

7. The method of claim 1 wherein the list comprises a start address and an indicator of a length of data to send that corresponds to the portions in the list.

8. A method comprising:
synchronizing a file between a first computer and a second computer including:
processing at the second computer including:
receiving a list indicating selected portions of the file at the second computer;
receiving data corresponding to the selected portions when the data is not already present in a memory of the second computer; and
combining the data with other portions of the file that are already present in the second node.

9. The method of claim 8 further comprising combining the data corresponding to the selected portions with the other portions of the file to form a whole version of the file.

10. The method of claim 9 comprising:
determining a signature for each portion of the whole version of the file; and
saving the signature to a cache.

11. The method of claim 8 further comprising:
processing at the second computer:
receiving the list;
determining a location of the selected portions on a network; and
retrieving the selected portions from the location.

12. The method of claim 11 wherein the location is not the first computer or the second computer.

13. A device comprising:
a memory including a cache to store at least one signature file;
a control circuit adapted to synchronize a data object between a first computer and a second computer, the control circuit further adapted to:
determine a list of portions of the data object that are different than corresponding portions of another version of the data object; and
send the list to the second computer.

14. The device of claim 13 wherein the control circuit is further adapted to:
partition the data object into portions;
determine a signature for each of the portions to produce a first signature file;
retrieve another signature file from the cache, the another signature file corresponding to the another version of the data object; and
compare the first signature file to the previous signature file.

15. The device of claim 13 wherein the control circuit is further adapted to:
determine the signature for each of the portions; and
combine the signature for each of the portions to produce the first signature file.

16. The device of claim 13 wherein the control circuit is further adapted to:
send data from the first computer to the second computer corresponding to the portions of the data object that are different than the corresponding portions of the previous version of the object.

17. The device of claim 13 wherein the control circuit further comprises a controller implementing firmware to synchronize the data object between the first computer and the second computer.

18. A computer readable medium embodying instructions that, when executed by a processor, cause the processor to:
synchronize a data object between a first node and a second node of a network, including processing in the first node comprising:
comparing a first signature file to a second signature file;
creating a list of portions of the data object to be synchronized based on the comparison; and
sending the list to the second node.

19. The computer readable medium of claim 18 further embodying instructions that, when executed by a processor, cause the processor to:
send data from the first node to the second node corresponding to the portions of the data object that are identified in the list.

20. The computer readable medium of claim 19 further embodying instructions that, when executed by a processor, cause the processor to:
synchronize the data object between the first node and the second node, further including processing in the second node comprising:
receiving the list indicating the portions of the data object to be synchronized;
receiving data corresponding to the portions in the list from another node on the network; and
building the data object in the second node by combining the received data with at least one other portion of the data object at the second node.
